(19) United States
(12) Patent Application Publication
(10) Pub. No.: US 2025/0123024 A1
(43) Pub. Date: Apr. 17, 2025

(54) BACKDRAFT DAMPER

(71) Applicant: Seeley International Pty Ltd, Lonsdale (AU)

(72) Inventors: Andrew Paul KUMNICK, Lonsdale (AU); Clinton Nero LEONARDIS, Adelaide (AU); Jack Henry ARNEY, Lonsdale (AU); James Allan BEARE, Lonsdale (AU); Nathan Grant BUDARICK, Lonsdale (AU); Murray Glenn OTTE, Lonsdale (AU); Robert William GILBERT, Adelaide (AU)

(21) Appl. No.: 18/916,429

(22) Filed: Oct. 15, 2024

Related U.S. Application Data
(60) Provisional application No. 63/590,864, filed on Oct. 17, 2023.

(51) Int. Cl. F24F 13/14; A62C 2/12

(52) U.S. Cl. CPC F24F 13/1486; A62C 2/12

(57) ABSTRACT

A backdraft damper assembly is shown and described herein. In one embodiment, a damper assembly comprises: a main body, the main body having an inner surface defining throat, the throat defining an axial fluid flow path; a first door, the first door being hingedly connected within the main body; and a second door, the second door being hingedly connected within the main body, the damper assembly being transitionable between an open configuration and a closed configuration, at least a portion of each of the first door and the second door being received within a portion of the inner surface of the main body when the damper assembly is in the open configuration, such that the first door and the second door are not within the axial fluid flow path.

### CROSS-REFERENCE TO RELATED APPLICATIONS

This application claims the benefit of the filing date of provisional U.S. Patent Application No. 63/590,864, filed Oct. 17, 2023, entitled BACKDRAFT DAMPER, the entirety of which is incorporated herein by reference.

### GOVERNMENT RIGHTS STATEMENT

N/A.

### TECHNICAL FIELD

This disclosure relates to backdraft dampers, including backdraft dampers for use in ventilation systems.

### BACKGROUND

Backdraft dampers can mitigate undesirable draughts by creating a flow obstruction that seals or significantly reduces an airflow leakage path in a pipe or duct system. The introduction of a backdraft damper effectively reduces cross-sectional area and creates an obstruction to what was an initially smooth and low resistance fluid path. Although backdraft dampers serve a useful purpose, their introduction creates flow obstructions and geometry transitions in the main body (from the damper door geometry and associated inlet and outlet connection flanges, etc.). These surface disruptions can amplify audible noise emissions, increase static and dynamic pressures losses, and reduce airflow. The shape of the backdraft damper, and the effectiveness of the design, can reduce flow performance as well as reflect undesirable sound and vibrations through a duct delivery system.

### SUMMARY

Some embodiments advantageously provide a backdraft damper assembly. In one embodiment, a damper assembly comprises: a main body, the main body including an inner surface defining throat, the throat defining an axial fluid flow path; a first door, the first door being hingedly connected within the main body; and a second door, the second door being hingedly connected within the main body, the damper assembly being transitionable between an open configuration in which the first door and the second door are not in contact with each other and a closed configuration in which the first door and the second door are at least partially in contact with each other, at least a portion of each of the first door and the second door being received within a portion of the inner surface of the main body when the damper assembly is in the open configuration, such that the first door and the second door are not within the axial fluid flow path.

In one aspect of the embodiment, the main body further includes: a mounting frame; and an inlet cone coupled to the mounting frame.

In one aspect of the embodiment, the mounting frame has a first mounting frame portion and a second mounting frame portion coupled to the first mounting frame portion.

In one aspect of the embodiment, the first door and the second door are sized and configured to completely prevent a flow of a fluid along the axial fluid flow path when the damper assembly is in the closed configuration.

In one aspect of the embodiment, each of the first door and the second door includes: a first end configured to be hingedly coupled to the main body; and a free second end configured for rotational movement within the main body, the free second end defining a mating surface.

In one aspect of the embodiment, the damper assembly further includes: a first hinge assembly, the first hinge assembly coupling the first door to the main body; and a second hinge assembly, the second hinge assembly coupling the second door to the main body.

In one aspect of the embodiment, the first hinge assembly is configured to be concealed behind the first door from the throat of the main body when the damper assembly is in the open configuration and the second hinge assembly is configured to be concealed behind the second door when the damper assembly is in the open configuration.

In one aspect of the embodiment, each of the first door and the second door includes at least one loop at the first end of the door, each of the first hinge assembly and the second hinge assembly including a shaft, the at least one loop of each of the first door and the second door being sized and configured to receive therein at least a portion of the shaft of a corresponding hinge assembly.

In one aspect of the embodiment, the shaft of each of the first hinge assembly and the second hinge assembly lies along an axis defining a rotational axis of a corresponding door, the rotational axis being at least substantially orthogonal to the axial fluid flow path.

In one aspect of the embodiment, the damper assembly is configured to transition from the closed configuration to the open configuration in response to a fluid flow acting against the first door and the second door from a first direction when the damper assembly is in the closed configuration.

In one aspect of the embodiment, the main body defines an inlet and an outlet, the first direction being from the inlet to the outlet of the main body.

In one aspect of the embodiment, the damper assembly is configured to transition from the open configuration to the closed configuration in the absence of a fluid flow passing through the throat when the damper assembly is in the open configuration and/or in response to a fluid flow acting against the first door and the second door from a second direction opposite the first direction when the damper assembly is in the open configuration.

In one aspect of the embodiment, each of the first door and the second door includes an undercut mechanism, the undercut mechanism having a protrusion. In one aspect of the embodiment, the protrusion is configured to be in contact with the inner surface of the main body to create a cavity between the door and the main body.

In one aspect of the embodiment, the inner surface of the main body defines at least one recessed portion, the at least one recessed portion being sized and configured to receive at least a portion of at least one of the first door and the second door when the damper assembly is in the open configuration.

In one aspect of the embodiment, the damper assembly further includes a first position sensor assembly associated with the first door and a second position sensor assembly associated with the second door, each of the first position sensor assembly and the second position sensor assembly including: a position sensor; and a permanent magnet, each of the first position sensor assembly and the second position sensor assembly being configured to sense a corresponding door is in a closed position when the permanent magnet is within a predetermined distance from the position sensor.

In one aspect of the embodiment, the damper assembly further includes a control unit, the control unit being in electrical communication with each of the first position sensor assembly and the second position sensor assembly.

In one embodiment, a damper assembly includes: a main body, the main body including an inner surface defining a throat, the throat defining an axial fluid flow path; a first door, the first door being hingedly connected within the main body; a second door, the second door being hingedly connected within the main body; a first hinge assembly, the first hinge assembly coupling the first door to the main body; and a second hinge assembly, the second hinge assembly coupling the second door to the main body, the damper assembly being transitionable between an open configuration in which the first door and the second door are not in contact with each other and a closed configuration in which the first door and the second door are at least partially in contact with each other, at least a portion of each of the first door and the second door being received within a portion of the inner surface of the main body when the damper assembly is in the open configuration such that the first door and the second door are not within the axial fluid flow path, the first hinge assembly being at least partially concealed behind the first door from the throat of the main body when the damper assembly is in the open configuration, and the second hinge assembly being at least partially concealed behind the second door from the throat of the main body when the damper assembly is in the open configuration, the first door and the second door being sized and configured to completely prevent a flow of fluid along the axial fluid flow path when the damper assembly is in the closed configuration.

In one aspect of the embodiment, the damper assembly is configured to transition from the closed configuration to the open configuration in response to a fluid flow acting against the first door and the second door from a first direction when the damper assembly is in the closed configuration; and the damper assembly is configured to transition from the open configuration to the closed configuration in the absence of a fluid flow passing through the throat when the damper assembly is in the open configuration and/or in response to a fluid flow acting against the first door and the second door from a second direction opposite the first direction when the damper assembly is in the open configuration.

In one embodiment, a door configured for use in a damper assembly includes: a first end being configured to be hingedly coupled to the damper assembly; a second end opposite the first end, the second end being a free end defining a mating surface; a first opposing side extending between the first end and the second end; a second opposing side extending between the first end and the second end, the second opposing side being opposite the first opposing side; a forward surface; and a rear surface opposite the forward surface, the door having a concave shape and at least one curvilinear edge.

### BRIEF DESCRIPTION OF THE DRAWINGS

A more complete understanding of embodiments described herein, and the attendant advantages and features thereof, will be more readily understood by reference to the following detailed description when considered in conjunction with the accompanying drawings wherein:

FIG. 1 shows a perspective view of a damper assembly, with some inner components exposed, in accordance with the present disclosure;

FIG. 2 shows an expanded view of a damper assembly, in accordance with the present disclosure;

FIG. 3 shows a perspective view of a damper assembly from a front (inlet side) view, the damper assembly being in an open configuration, accordance with the present disclosure;

FIG. 4 shows a perspective view of the damper assembly of FIG. 3 from a front (inlet side) view, the damper assembly being in a closed configuration, in accordance with the present disclosure;

FIG. 5 shows a perspective view of a damper assembly from a rear (outlet side) view, the damper assembly being in an open configuration, in accordance with the present disclosure;

FIG. 6 shows a perspective view of the damper assembly of FIG. 5 from a rear (outlet side) view, the damper assembly being in a closed configuration, in accordance with the present disclosure;

FIG. 7 shows a rear (outlet side) view of a damper assembly, the damper assembly being in an open configuration, in accordance with the present disclosure;

FIG. 8 shows a rear (outlet side) view of the damper assembly of FIG. 7, the damper assembly being in a closed configuration, in accordance with the present disclosure;

FIG. 9 shows a side cross-sectional view of a damper assembly, the damper assembly being in a closed configuration, in accordance with the present disclosure;

FIG. 10 shows a side cross-sectional view of the damper assembly of FIG. 9, the damper assembly being in an open configuration, in accordance with the present disclosure;

FIG. 11 shows a close-up view of a portion of a damper assembly, the damper assembly including an undercut mechanism, in accordance with the present disclosure;

FIG. 12 shows a side cross-sectional view of a damper assembly, the door being removed to illustrate a configuration of an inner surface of the damper assembly, in accordance with the present disclosure;

FIG. 13 shows a perspective view of a portion of a damper assembly, the door being removed to illustrate a configuration of an inner surface of the damper assembly, in accordance with the present disclosure;

FIG. 14 shows a side cross-sectional view of a damper assembly, the damper assembly having a recessed portion to receive a door, in accordance with the present disclosure;

FIG. 15 shows a rear close-up view of a portion of a damper assembly, in accordance with the present disclosure; and

FIG. 16 shows a close-up view of a portion of a damper assembly, the damper assembly including a position sensor assembly, in accordance with the present disclosure.

### DETAILED DESCRIPTION

Before describing in detail exemplary embodiments, it is noted that the embodiments reside primarily in combinations of apparatus components and steps related to backdraft damper assemblies. Accordingly, the system and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

A damper assembly such as that shown and described herein may be suitable for use in an air handler to direct and condition air flow streams through a series of carefully organized components, and/or may be suitable for use in an air handling or ventilation ducting system to direct and condition air flow streams through a space, such as one or more rooms within a commercial or residential building.

In one embodiment, a damper assembly such as that shown and described herein includes a generally cylindrical or annular main body that defines a continuous fluid path extending between a first opening and a second opening of the main body. Damper doors are rotatable within the main body to control the flow of fluid (for example, air) through the main body. The damper assembly may include two doors. The damper doors are configured such that they are rotatable between a first position in which the doors are positioned flush with an inner diameter, or throat, of the main body to permit air flow through the main body (open configuration) and a second position in which the doors form a seal between mating surfaces of the doors to block air flow through the main body (closed configuration). The doors are passively actuated via positive pressure fluid flow for opening, and gravity or an opposing positive pressure fluid flow in the reverse direction and/or biasing force for closing. No directly driven powered mechanisms are required for actuation. The doors can rotate backward and forward in the axial direction of the main body, and are closable by gravity alone. They are pivotably suspended on a shaft and bearings of hinge assemblies. When in the open position or configuration, the doors tuck into one or more recesses in the main body geometry (for example, within the throat) to hide the hinge assemblies from the main fluid path to minimize noise and air resistance losses.

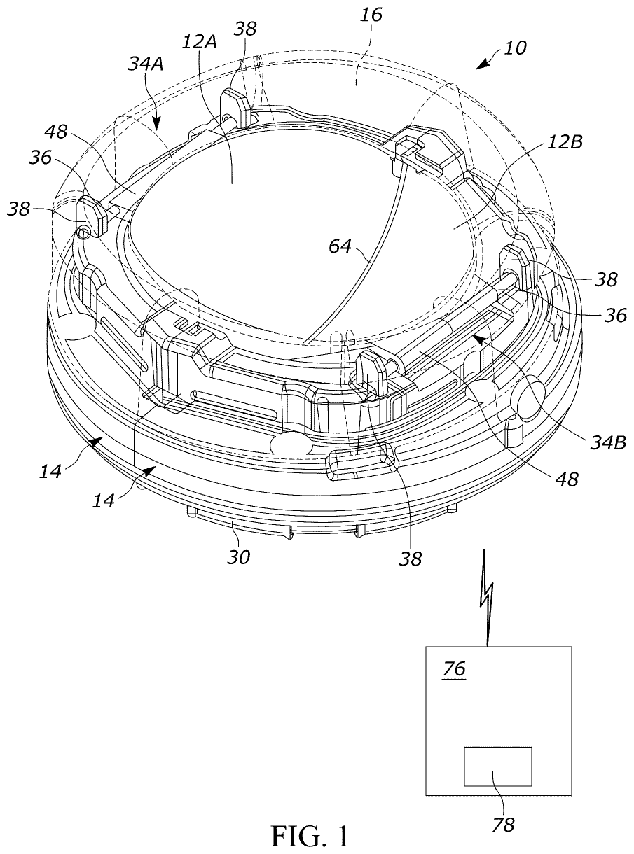

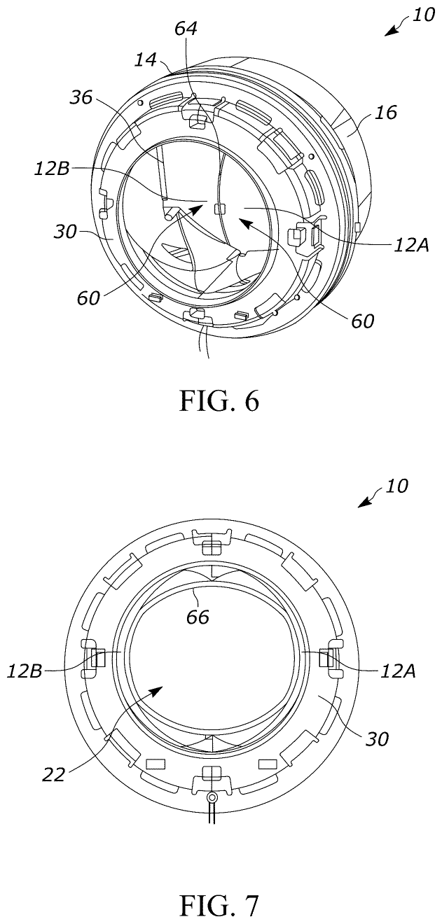

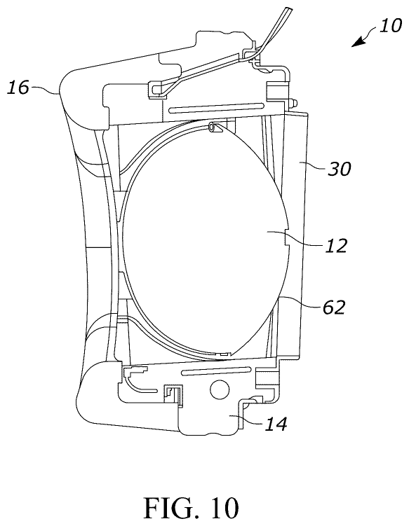

Referring now to the figures in which like reference designators are used for like elements, a backdraft damper assembly 10 (also referred to herein as a “damper assembly”) is shown in FIGS. 1-16. In one embodiment, the damper assembly 10 generally includes a pair of doors 12 (a first door 12A and a second door 12B), a mounting frame 14, and an inlet venturi 16 (which appears transparent in FIG. 1 to better show the first and second doors, is referred to herein as an “inlet cone”). In one embodiment, at least a portion of the inlet cone 16 defines a first opening 18A of the damper assembly 10 and at least a portion of the mounting frame 14 defines second opening 18B of the damper assembly 10. The first opening 18A and/or the second opening 18B may be annular, at least substantially annular, or oval (for example, as shown in n FIG. 7). In one embodiment, the inlet cone 16 and the mounting frame 14 together at least partially define the main body 20 of the damper assembly 10. The main body 20 defines a throat 22 that extends along an axis 24 of the main body, through which air may flow in an axial direction (that is, also along the axis 24 of the main body) from the first opening 18A toward the second opening 18B, or from the second opening 18B toward the first opening 18A. As is discussed in greater detail below, in one embodiment an inner surface 26 of the main body 20 at least partially defines the throat 22, and is contoured to define one or more recesses that are sized and/or configured to receive at least a portion of each door 12.

In one example of operation, a flow of air enters the damper assembly 10 through the inlet cone 16. In one embodiment, the first door 12A and the second door 12B are each configured to passively transition from a closed (first) configuration to an open (second) configuration as the flow of air enters the damper assembly 10 and creates a force against the first and second doors 12A, 12B. In one embodiment, the first and second doors 12A, 12B are configured to passively transition from an open (second) configuration to a closed (first) configuration when the flow of air is not entering, or has stopped entering, the damper assembly and is no longer exerting a force against the first and second doors 12A, 12B and/or if the flow of air is flowing in an opposite direction wherein it exits the damper assembly 10 through the inlet cone 16. That is, the first and second doors 12A, 12B are passively actuatable in response to a positive fluid pressure. In one embodiment, the doors 12A, 12B are biased to the closed configuration. In one non-limiting example, the damper assembly 10 includes one or more springs as biasing components that act against the doors 12A, 12B. In one embodiment, a force of gravity causes the doors 12A, 12B to transition to the closed configuration in absence of the flow of air through the damper assembly 10, without biasing component(s).

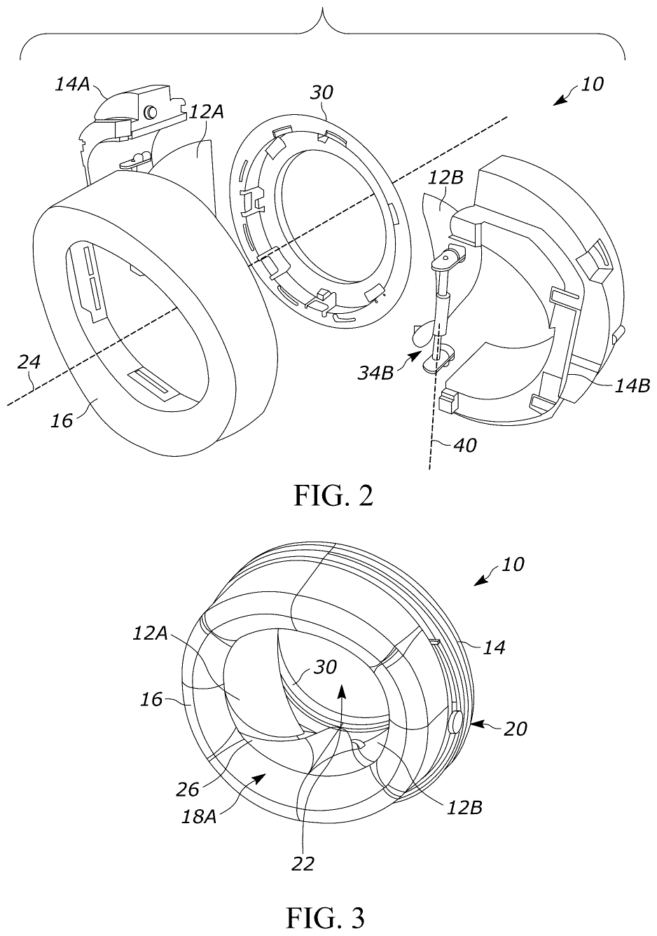

FIG. 2 shows an exploded view of the damper assembly 10. In one embodiment, the inlet cone 16 is formed (for example, by molding, casting, or other methods) as a single, unitary piece. In another embodiment, the inlet cone 16 is formed as one or more separate pieces that are then permanently joined (for example, by welding, chemical bonding, adhesives, or other methods) or removably joined (for example, by snap fit, friction fit, rotational threading, or other methods) to each other before being coupled to the other components of the damper assembly 10. In some embodiments, the inlet cone 16 has a first or forward surface with at least a portion thereof being curved or having smooth transitions or other features that do not present impediments to or disruption in airflow. In fact, in some embodiments, the geometry of the first surface is configured such that air from a plurality directions, including from directions that are perpendicular, or at least substantially perpendicular, to the primary direction of air flow through the damper assembly 10, can be drawn into the first opening 18A of the damper assembly 10 without, or with minimal, impediment. This first surface is the outward or forward-facing surface of the damper assembly 10, as shown in FIG. 3. In some embodiments, the inlet cone 16 also has a second or rearward surface opposite the first surface. In some embodiments, this second surface includes one or more mating elements, including but not limited to snap-fit components, bore hole and pin/dowel combinations, friction fit components, screws, bolts, or other suitable elements for connecting the inlet cone 16 to the mounting frame 14 without affecting functionality, air flow through the damper assembly, and/or movement of the first and second doors 12A, 12B. In some embodiments, the second surface of the inlet cone 16 is, defines, or includes at least one recessed portion that is sized and configured to contain at least one other system component. For example, as discussed below, in one embodiment the second surface of the inlet cone 16 is sized and configured to receive at least a portion of a hinge assembly of each door.

In one embodiment, the mounting frame 14 includes a first mounting frame portion 14A and a second mounting frame portion 14B, which are configured to be releasably or permanently attached to each other. In one embodiment, each of the first and second mounting frame portions 14A, 14B includes one or more mating elements, including but not limited to snap-fit components, bore hole and pin/dowel combinations, friction fit components, screws, bolts, or other suitable elements for connecting the first and second mounting frame portions 14A, 14B without affecting functionality, air flow through the damper assembly, and/or movement of the first and second doors 12A, 12B. In other embodiments, the mounting frame 14 is formed (for example, by molding, casting, or other methods) as a single, unitary piece or is formed as separate piece that are then permanently joined (for example, by welding, chemical bonding, adhesives, or other methods) or removably joined (for example, by snap fit, friction fit, rotational threading, or other methods) to each other before being coupled to the other components of the damper assembly 10. In one embodiment, the inlet cone 16 is coupled or couplable to the mounting frame 14. In one embodiment, each of the inlet cone 16 and the mounting frame 14 are composed of one or more materials that are lightweight and provide thermal insulation and noise attenuation. For example, the inlet cone 16 and the mounting frame 14 may be composed of expanded polypropylene (EPP) foam. However, other materials may be used alone or in combination, including but not limited to expanded polystyrene (EPS) foam, expanded polyolefin (EPO) foam, expanded polyethylene foam (EPE), plastics, or the like. Additionally, in one embodiment an inner surface 26 of the main body 20 may be coated or lined with one or more materials to provide resistance to, or durability despite, high pressure and/or temperatures.

Continuing to refer to FIGS. 1-16, in one embodiment the damper assembly 10 further includes a coupling bracket 30 that is configured to removably couple the damper assembly 10 to an opening of an air duct or conduit. In one embodiment, the coupling bracket 30 is attached to the main body 20 (for example, the mounting frame 14) and includes one or more structural features 32 that allow the coupling bracket 30 (and the damper assembly 10) to be easily removed from complementary structural features of an air duct of conduit, such as by a bayonet connection. However, other suitable means may be used to removably or permanently couple the damper assembly 10 to an air duct or conduit.

Continuing to refer to FIGS. 1-16, each of the first door 12A and the second door 12B are hingedly connected to the mounting frame 14. In one embodiment, the damper assembly 10 further includes a first hinge assembly 34A that is configured to couple the first door 12A to the mounting frame 14 (in some embodiments, the first mounting frame portion 14A) and a second hinge assembly 34B that is configured to couple the second door 12B to the mounting frame 14 (in some embodiments, the second mounting frame portion 14B). In some embodiments, each hinge assembly 34A, 34B includes an elongate cylindrical shaft 36 that defines an axis of rotation for its associated door. In one embodiment, each hinge assembly 34A, 34B also includes at least one bearing 38 for coupling the corresponding shaft 36 to the mounting frame 14. Additionally or alternatively, the main body 20 may at least partially define a portion of the hinge assembly 34A, 34B, such as brackets and/or recesses configured to retain the shaft 36 therein. In one embodiment, such as is shown in FIG. 1, each bearing 38 includes an aperture through which at least a portion of the shaft 36 may pass, or within which at least a portion of the shaft 36 may be received. For example, as shown in FIGS. 1 and 2, each hinge assembly 34A, 34B may include two bearings 38. Additionally or alternatively, a bearing 38 may be coupled to each end of the shaft, either permanently (for example, by welding, chemical bonding, adhesives, or other methods) or removably (for example, by snap fit, friction fit, rotational threading, or other methods). In one embodiment, the bearings 38 are located at or proximate opposite ends of the shaft 36. Each hinge assembly 34A, 34B may also include one more bearings to facilitate rotation, stoppers or flanges to prevent the hinge from falling away from the bearings, one or more springs to bias the doors 12A, 12B into a closed configuration, and/or other suitable components to enhance transition of the doors 12A, 12B between the open and closed configurations. The components of each hinge assembly 34A, 34B cooperate with each other with low friction, so the doors 12A, 12B may swing easily and smoothly about the shafts 36. Additionally, in some embodiments each hinge assembly 34A, 34B is at least partially received within the inlet cone 16 (such as within a rear surface of the inlet cone 16) such that each hinge assembly 34A, 34B is concealed within the inlet cone 16 and/or other components of the damper assembly 10, and are isolated from the air flowing through the damper assembly 10 where they will not disrupt laminar flow or create other airflow inefficiencies. Likewise, in this manner no part of each hinge assembly 34A, 34B penetrates through the damper assembly 10 to an external environment to cause or create air leakage paths from within the damper assembly 10. Such a configuration facilitates movement of the doors during operation more than some other rotational means, such as living hinges.

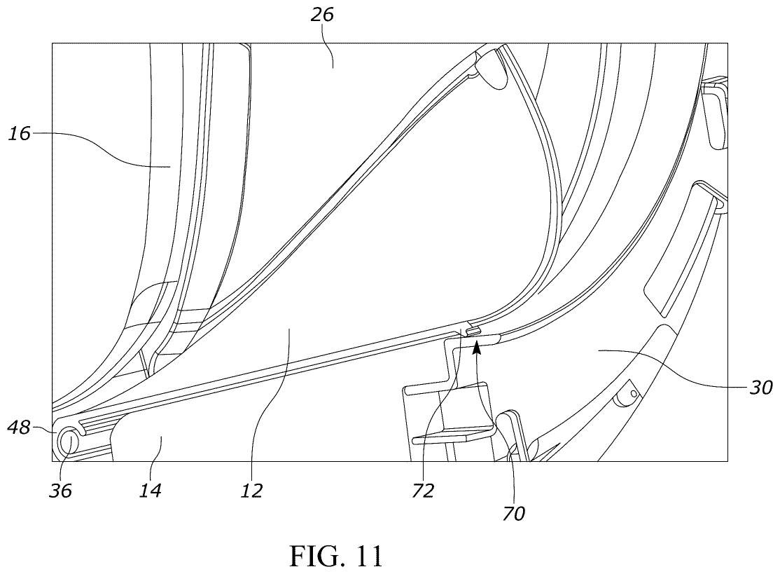

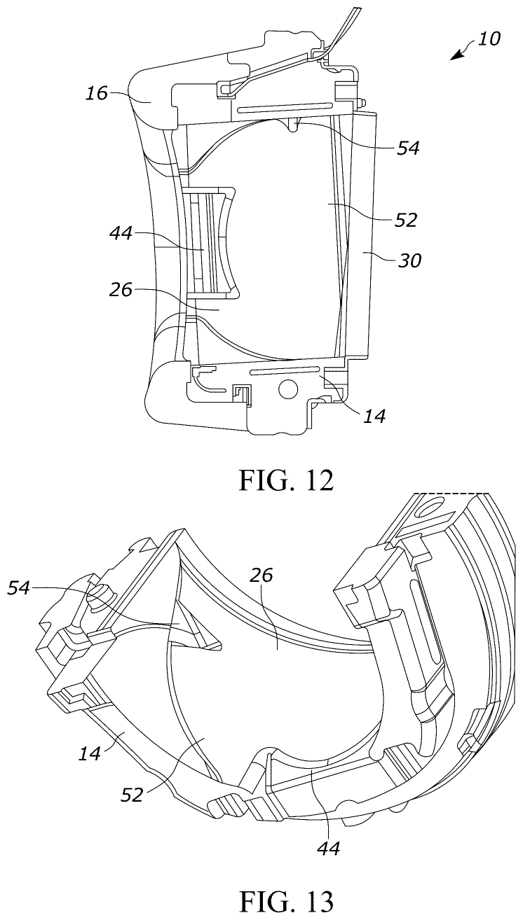

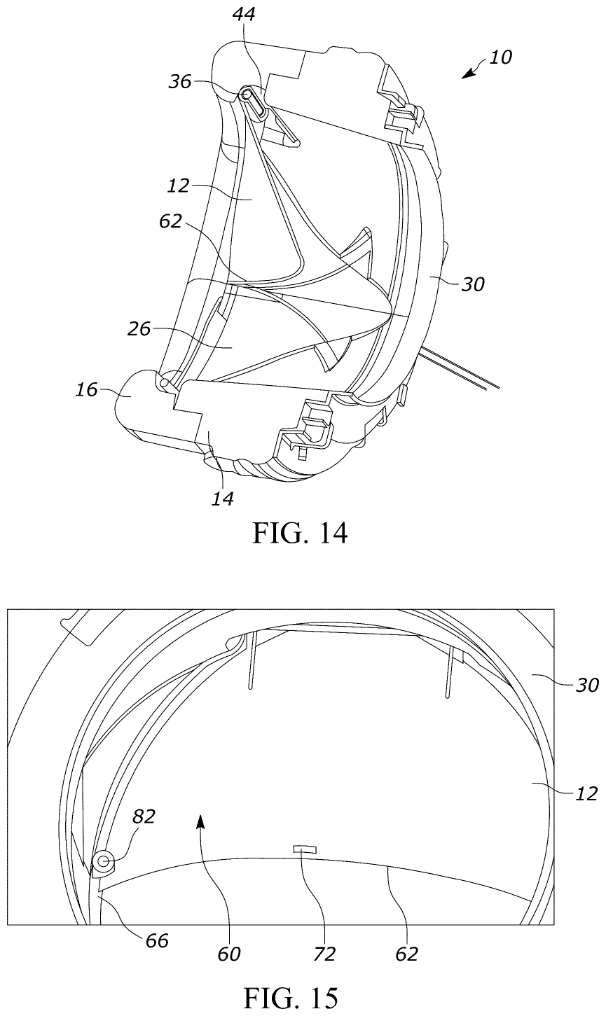

Continuing to refer to FIGS. 1-16, in one embodiment, the shaft 36 of each hinge assembly 34A, 34B extends along an axis 40 that lies in a direction that is orthogonal or at least substantially orthogonal from an axial direction of air flow within the main body between the first opening and the second opening (that is, an axial direction of air flow along the axis 24 of the main body 20). The axis 40 of each shaft 36 defines a rotational axis for the corresponding door 12. Put another way, in one embodiment the shaft 36 of each hinge assembly 34A, 34B extends in a direction that is orthogonal or at least substantially orthogonal to a diameter of the main body 20 that intersects the shaft 36. In one embodiment, the shafts 36 of the hinge assemblies 34A, 34B do not extend into the throat 22 of the main body 20 or otherwise interfere with the flow of air through the damper assembly 10. Further, in one embodiment each hinge assembly 34A, 34B is enclosed or hidden within the main body 20 and/or the inlet cone 16 to conceal it from the fluid flow path, as shown in FIGS. 7 and 14. For example, in FIG. 12 the door 12 is removed to show a hinge assembly recess 44 that is at least partially defined by the main body 20, such as by a portion of the inlet cone 16 and/or a portion of the mounting frame 14. For example, in one embodiment, the hinge assembly recess 44 is at least partially defined by the second surface of the inlet cone 16. Additionally, the loops 48 are configured and oriented such that when the doors 12A, 12B are in the open configuration, the hinge assemblies 34A, 34B are at least partially concealed behind the doors 12A, 12B (for example, as shown in FIG. 11). Thus, each hinge assembly 34A, 34B is located external to the fluid flow path through the main body 20, not within the fluid flow path. Put another way, each of the first and second hinge assemblies 34A, 34B are concealed from the axial fluid flow path by its corresponding door 12A, 12B and/or by other components of the damper assembly 10 when the doors are open when the damper assembly 10 is in the open configuration.

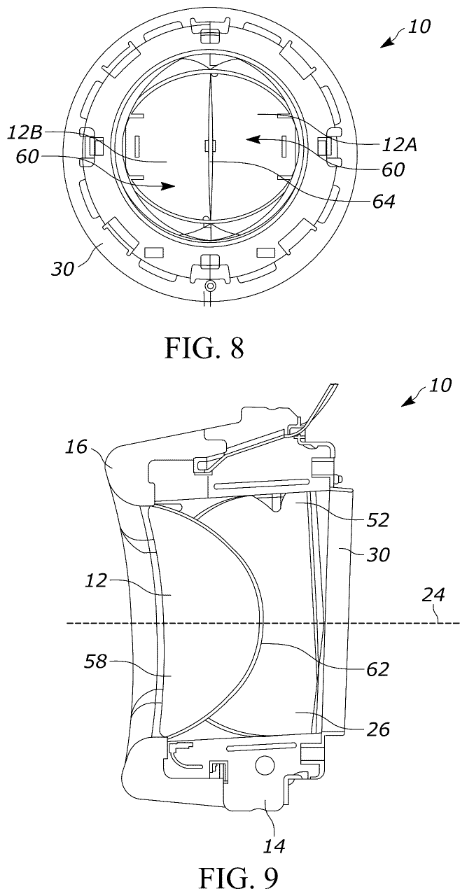

Continuing to refer to FIGS. 1-16, in one embodiment each door 12A, 12B is composed of a material that provides resistance to, or durability despite, high pressure and/or temperatures without breaking, cracking, deforming, melting, or otherwise becoming damaged. In one embodiment, the doors 12A, 12B are composed of a one or more rigid plastics, polymers, fiberglass, carbon fiber, and/or other suitable material(s). In one embodiment, when viewed from the front or the back, each of the first door 12A and the second door 12B have a semicircular shape (for example, this can be seen in FIG. 8). In one embodiment each door 12A, 12B generally includes a first end that is configured to be pivotably attached to the main body 20 (for example, by the corresponding hinge assembly 34) and a second end opposite the first end that is a free end that is movable within the throat 22 of the main body 20. Each door 12A, 12B rotates about the rotational axis 40 provided by the shaft 36 in its corresponding hinge assembly 34A, 34B. Rotational movement of each door 12A, 12B may be limited by the hinge assembly 34A, 34B and/or the main body 20. In one embodiment, each door 12A, 12B includes at least one loop 48 along a first edge portion at the first end of the door that is sized and configured receive therethrough the shaft 36 of the corresponding hinge assembly 34A, 34B.

Continuing to refer to FIGS. 1-16, in one embodiment, each of the first door 12A and the second door 12B have a curved shape that is sized and configured to follow a contour of at least a portion of the inner surface 26 of the main body 20 (for example, the inner surface 26 of the mounting frame 14, as shown in FIGS. 12-14) when the doors are in the open configuration. Further, in one embodiment at least a first portion of the inner surface 26 of the main body 20 defines at least one recess that is sized and configured to receive at least a portion of the first door 12A, and at least a second portion of the inner surface 26 defines at least one recess that is sized and configured to receive at least a portion of the second door 12B. The main body 20 may be configured and shaped such that the recesses are discrete or joined. Further, the recesses may smoothly transition into each other and/or into other portions of the main body 20 to present smooth surfaces to the fluid flow within the throat 22. In one embodiment, the inner surface 26 of the main body 20 includes one or more main recesses 52 that are sized and configured to accept at least a portion of one or both doors 12 and one or more free edge recesses 54 that are sized and configured to accept at least a portion of the opposing edges and/or free edges of one or both doors 12A, 12B when the damper assembly 10 is in the open configuration. In such a configuration, each of the first and second doors 12A, 12B are at least partially received within at least one recess such that the first and second doors do not obstruct or adversely affect a fluid flow through the throat 22 of the damper assembly 10 when the damper assembly is in the open configuration (for example, as shown in FIGS. 3, 5, 7, and 10). Each door 12A, 12B defines a forward surface 58 and a rear surface 60. For example, when the damper assembly 10 is in the open configuration, all or at least substantially all of the rear surface 60 of each door 12A, 12B may be in contact with or immediately proximate the inner surface 26 of the main body 20. That is, the doors 12A, 12B may be flush to, or at least substantially flush to, the inner surface 26. In one embodiment, each door 12A, 12B is mounted within the throat 22 at an approximately 5° (±2° draft angle so the doors will be pinned flush against the inner surface 26 when in the open configuration. This lack of, or minimal, obstruction to the fluid flow path through the main body 20 results in minimal flow losses during operation.

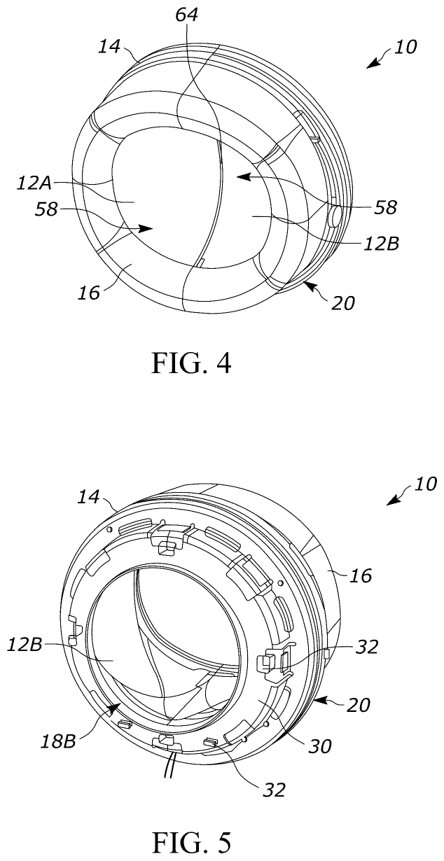

Continuing to refer to FIGS. 1-16, in one embodiment each door 12A, 12B also includes a mating surface 62 along an edge of the second end of the door. In one embodiment, the mating surface 62 of each door 12A, 12B is along the free edge of the door. In one embodiment, the first and second doors 12A, 12B together define a concave shape when the damper assembly 10 is in the closed configuration (for example, as shown in FIGS. 1, 4, 6, 8, and 9) and when viewed from the inlet side of the damper assembly 10. For example, as is shown in FIG. 9, the forward surface of each door has a concave shape and the rear surface of each door has a convex shape, and the together the first and second doors 12A, 12B may generally define a hemispherical or cupped shape when the doors are in the closed configuration. In one embodiment, the mating surface 62 of the first door 12A and the mating surface 62 of the second door 12B meet and are in contact with each other to define a seam 64 when the damper assembly 10 is in the closed configuration. In one embodiment, the mating surface 62 of each door 12A, 12B is curvilinear (to follow the concavity of the door), with the seam 64 appearing as a vertical line across the throat 22 or first opening 18A of the damper assembly 10 when the damper assembly 10 is viewed from the front and is in the closed configuration. Alternatively, the seam 64 may appear as a horizontal line, or straight or at least substantially straight line across the throat 22 or first opening 18A of the damper assembly, depending on the rotational orientation of the view and/or the damper assembly 10. Additionally, the opposing edges of each door 12A, 12B that extend between the first end and the second end of each door are curved. In some embodiments, the curvature of the opposing edges of each door 12A, 12B is configured to follow the inner surface 26 of at least a portion of the main body 20 such that the opposing edges are in contact with or immediately proximate the inner surface 26 of the main body 20 (in one embodiment, the inner surface 26 of the mounting frame 14) when the damper assembly 10 is in the closed configuration (for example, as shown in FIGS. 4 and 8). Put another way, a diameter of the first door 12A and the second door 12B together when in a closed configuration is the same as or substantially the same as (for example, within 0.55 mm of) an inner diameter of the main body 20, or outer diameter of the throat 22, to create a seal that prevents fluid flow through the throat 22. In one embodiment, an entirety of each opposing edge of each door 12A, 12B is in contact with or immediately proximate the inner surface 26 of the main body 20 to define a seal with the main body when the damper assembly 10 is in the closed configuration.

In one embodiment, as shown in FIG. 15, an inner surface of the inlet cone 16 and/or the mounting frame 14 includes or defines an annular or at least substantially annular sealing face 68 that extends a small distance into the throat 22. For example, the sealing face 68 may extend approximately 3.5 mm (±0.5 mm) into the throat 22. In one embodiment, the sealing face 68 is a rigid or semi-rigid material that is at least slightly compressible, such as foam. The sealing face 68 may be composed of the same or different material than the inlet cone 16 and/or the mounting frame 14, and may be coupled to the inlet cone 16 and/or mounting frame 14, or may be integrally formed with the inlet cone 16 or mounting frame 14 as a single, unitary piece. In one embodiment, the sealing face 68 is an annular, planar piece of foam that is squeezed between the inlet cone 16 and the mounting frame 14 when the main body 20 is assembled. In one embodiment, the forward surface 58 of each door 12A, 12B presses against a rear surface of the sealing face 68 to create or enhance the seal between the doors 12A, 12B and the inner surface of the main body 20. Thus, when the damper assembly 10 is in the closed configuration, fluid flow through the main body 20 is prevented to achieve no or very minimal leakage.

In one embodiment, the damper assembly 10 is a passive system, and no motor or other actuator is required to actuate the doors 12A, 12B and/or to transition the damper assembly 10 between the open and closed positions. A positive fluid pressure acting in a first direction against the forward surfaces 58 of the doors 12A, 12B (for example, a fluid flow moving in an axial direction from the first opening 18A toward the second opening 18B of the main body 20) causes the doors 12A, 12B to swing inward within the throat 22, toward the inner surface 26, to transition the damper assembly 10 from a closed configuration to an open configuration. The concave configuration of the doors 12A, 12B in the closed configuration may facilitate opening. A positive fluid pressure acting in a second direction opposite the first direction (for example, a fluid flow moving in an axial direction from the second opening 18B toward the first opening 18A) causes the doors 12A, 12B to swing outward within the throat 22, toward the first opening 18A, to transition the damper assembly 10 from an open configuration to a closed configuration. In some embodiments, the doors 12A, 12B are opened with minimal air flow therethrough, and gravity alone is sufficient to cause the doors 12A, 12B to swing outward within the throat 22, toward the first opening 18A, to transition the damper assembly 10 from the open configuration to the closed configuration in absence of a positive fluid pressure, or when the positive fluid pressure (fluid flow) decreases (that is, when air flow is absent or nearly absent). In some embodiments, the damper assembly 10 includes one or more springs that are positioned and configured to bias the doors 12A, 12B toward the closed configuration in the absence of a fluid flow within the main body 20. In one non-limiting example, each hinge assembly 34A, 34B may also include one or more springs to achieve such a result. In other embodiments, the damper assembly 10 does not include springs or other biasing components.

In one embodiment, as shown in FIG. 11, the damper assembly 10 includes an undercut mechanism 70 that produces aerodynamic lift force perpendicular to its direction of motion to rapidly shut the doors 12A, 12B to transition the damper assembly 10 to the closed configuration when a fluid flow is introduced to create a positive fluid pressure acting in the second direction. For example, in one embodiment, each door 12A, 12B includes a protrusion 72 on its rear surface 60, proximate the mating surface 62, that is configured to come into contact with the inner surface 26 of the main body 20 and/or the mounting frame 14 to prop up the door 12 and maintain a small cavity between the door 12 and the main body 20. When a fluid flow in the second direction is present, fluid (air) rushes into the small cavity and creates a high-pressure region that exerts a lift force on the underside of the door 12. This force causes the door 12 to swing away from the inner surface 26 of the main body 20 and toward the closed configuration. As each door 12A, 12B moves away from the inner surface 26, the angle of attack increases and so does the force, causing the doors 12A, 12B to be rapidly thrown shut.

In one aspect of the embodiment, the damper assembly 10 is in wired and/or wireless communication with a control unit 76. In some embodiments, the control unit 76 includes processing circuitry 78 having a processor and a memory. In some embodiments, the memory is in electrical communication with the processor and has instructions that, when executed by the processor, configure the processor to perform one or more system functions, such as to present usage data or information to a user (such as through one or more peripheral display devices, including, but not limited to, one or more screens, displays, or tablets), to present or communicate operational messages to a user (such as current and/or historical fault conditions), to perform one or more analyses or calculations (such as to determine if a fault condition is present), or the like. The control unit 76 may include one or more peripheral user input devices, including, but not limited to, touchscreens, buttons, dials, remote controls, or the like.

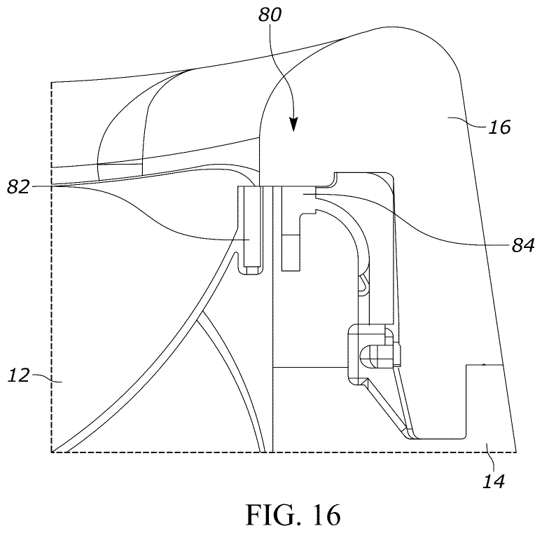

As shown in FIG. 16, in one embodiment, the damper assembly 10 includes a position sensor assembly 80 associated with one or both doors, such as is shown in FIG. 16. In one embodiment, the control unit 76 is programmed or programmable to receive a signal from each position sensor assembly 80 to detect a rotational position of the corresponding door 12. In one embodiment, each door 12A, 12B includes a permanent magnet 82 (for example, a cylindrical permanent magnet within or at least partially within the door) and the main body 20 includes a position sensor 84, such as a magnet reed switch, at a location proximate the permanent magnet 82 when the associated door 12 is in the closed configuration. In some embodiments, each permanent magnet 82 is coupled to, embedded within, or otherwise on the corresponding door 12 at a location that is at or proximate the inner surface 26 of the main body 20 when the door 12 is in the closed configuration. In one non-limiting example, the permanent magnet 82 may be at or proximate both the free edge of the door 12 and an opposing edge of the door, as shown in FIG. 15. For example, a position sensor 84 may be positioned within a predetermined distance, such as approximately 6.5 mm (±0.25 mm), from a corresponding magnet 82 when the doors 12A, 12B are in the closed configuration. In one embodiment, when a position sensor 84 recognizes the presence of a corresponding magnet 82, it senses and sends a signal to the control unit 76 communicating that the door is closed. If the damper assembly 10 includes a position sensor assembly 80 for each door 12A, 12B, and the control unit 76 receives signals corresponding to one closed door and one open door, the control unit 76 is programmed or programmable to determine and communicate a fault condition.

### Embodiments

Some embodiments advantageously provide a backdraft damper assembly. In one embodiment, a damper assembly comprises: a main body, the main body having an inner surface defining throat, the throat defining an axial fluid flow path; a first door, the first door being hingedly connected within the main body; and a second door, the second door being hingedly connected within the main body, the damper assembly being transitionable between an open configuration and a closed configuration, at least a portion of each of the first door and the second door being received within a portion of the inner surface of the main body when the damper assembly is in the open configuration, such that the first door and the second door are not within the axial fluid flow path.

In one aspect of the embodiment, the main body includes: a mounting frame; and an inlet cone coupled to the mounting frame. In one aspect of the embodiment, the mounting frame has a first mounting frame portion and a second mounting frame portion coupled to the first mounting frame portion.

In one aspect of the embodiment, the first door and the second door are sized and configured to prevent a flow of a fluid along the axial fluid flow path when the damper assembly is in the closed configuration. In one aspect of the embodiment, each of the first door and the second door includes: a first end configured to be hingedly coupled to the main body; and a free second end configured for rotational movement within the main body.

In one aspect of the embodiment, the damper assembly further comprises: a first hinge assembly, the first hinge assembly coupling the first door to the main body; and a second hinge assembly, the second hinge assembly coupling the second door to the main body. In one aspect of the embodiment, each of the first door and the second door includes at least one loop, each of the first hinge assembly and the second hinge assembly includes a shaft, the at least one loop of each of the first door and the second door being sized and configured to receive therein at least a portion of the shaft of a corresponding hinge assembly.

In one aspect of the embodiment, the damper assembly is configured to transition from the closed configuration to the open configuration in response to a fluid flow acting against the first door and the second door from a first direction when the damper assembly is in the closed configuration. In one aspect of the embodiment, the damper assembly is configured to transition from the open configuration to the closed configuration: in the absence of a fluid flow passing through the throat when the damper assembly is in the open configuration; or in response to a fluid flow acting against the first door and the second door from a second direction opposite the first direction when the damper assembly is in the open configuration.

In one aspect of the embodiment, the inner surface of the main body defines at least one recessed portion, the at least one recessed portion being sized and configured to receive at least a portion of at least one of the first door and the second door when the damper assembly is in the open configuration.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention.

What is claimed is:

1. A damper assembly comprising:
a main body, the main body including an inner surface defining throat, the throat defining an axial fluid flow path;
a first door, the first door being hingedly connected within the main body; and
a second door, the second door being hingedly connected within the main body,
the damper assembly being transitionable between an open configuration in which the first door and the second door are not in contact with each other and a closed configuration in which the first door and the second door are at least partially in contact with each other, at least a portion of each of the first door and the second door being received within a portion of the inner surface of the main body when the damper assembly is in the open configuration, such that the first door and the second door are not within the axial fluid flow path.

2. The damper assembly of claim 1, wherein the main body further includes:
a mounting frame; and
an inlet cone coupled to the mounting frame.

3. The damper assembly of claim 2, wherein the mounting frame has a first mounting frame portion and a second mounting frame portion coupled to the first mounting frame portion.

4. The damper assembly of claim 1, wherein the first door and the second door are sized and configured to completely prevent a flow of a fluid along the axial fluid flow path when the damper assembly is in the closed configuration.

5. The damper assembly of claim 4, wherein each of the first door and the second door includes:
a first end configured to be hingedly coupled to the main body; and
a free second end configured for rotational movement within the main body, the free second end defining a mating surface.

6. The damper assembly of claim 5, further comprising:
a first hinge assembly, the first hinge assembly coupling the first door to the main body; and
a second hinge assembly, the second hinge assembly coupling the second door to the main body.

7. The damper assembly of claim 6, wherein the first hinge assembly is configured to be concealed behind the first door from the throat of the main body when the damper assembly is in the open configuration and the second hinge assembly is configured to be concealed behind the second door when the damper assembly is in the open configuration.

8. The damper assembly of claim 6, wherein each of the first door and the second door includes at least one loop at the first end of the door, each of the first hinge assembly and the second hinge assembly including a shaft, the at least one loop of each of the first door and the second door being sized and configured to receive therein at least a portion of the shaft of a corresponding hinge assembly.

9. The damper assembly of claim 8, wherein the shaft of each of the first hinge assembly and the second hinge assembly lies along an axis defining a rotational axis of a corresponding door, the rotational axis being at least substantially orthogonal to the axial fluid flow path.

10. The damper assembly of claim 1, wherein the damper assembly is configured to transition from the closed configuration to the open configuration in response to a fluid flow acting against the first door and the second door from a first direction when the damper assembly is in the closed configuration.

11. The damper assembly of claim 10, wherein the main body defines an inlet and an outlet, the first direction being from the inlet to the outlet of the main body.

12. The damper assembly of claim 10, wherein the damper assembly is configured to transition from the open configuration to the closed configuration in the absence of a fluid flow passing through the throat when the damper assembly is in the open configuration and/or in response to a fluid flow acting against the first door and the second door from a second direction opposite the first direction when the damper assembly is in the open configuration.

13. The damper assembly of claim 12, wherein each of the first door and the second door includes an undercut mechanism, the undercut mechanism having a protrusion.

14. The damper assembly of claim 13, wherein the protrusion is configured to be in contact with the inner surface of the main body to create a cavity between the door and the main body.

15. The damper assembly of claim 1, wherein the inner surface of the main body defines at least one recessed portion, the at least one recessed portion being sized and configured to receive at least a portion of at least one of the first door and the second door when the damper assembly is in the open configuration.

16. The damper assembly of claim 1, further comprising a first position sensor assembly associated with the first door and a second position sensor assembly associated with the second door, each of the first position sensor assembly and the second position sensor assembly including:
a position sensor; and
a permanent magnet,
each of the first position sensor assembly and the second position sensor assembly being configured to sense a corresponding door is in a closed position when the permanent magnet is within a predetermined distance from the position sensor.

17. The damper assembly of claim 16, further comprising a control unit, the control unit being in electrical communication with each of the first position sensor assembly and the second position sensor assembly.

18. A damper assembly, the damper assembly comprising:
a main body, the main body including an inner surface defining a throat, the throat defining an axial fluid flow path;
a first door, the first door being hingedly connected within the main body;
a second door, the second door being hingedly connected within the main body;
a first hinge assembly, the first hinge assembly coupling the first door to the main body; and
a second hinge assembly, the second hinge assembly coupling the second door to the main body,
the damper assembly being transitionable between an open configuration in which the first door and the second door are not in contact with each other and a closed configuration in which the first door and the second door are at least partially in contact with each other,
at least a portion of each of the first door and the second door being received within a portion of the inner surface of the main body when the damper assembly is in the open configuration such that the first door and the second door are not within the axial fluid flow path, the first hinge assembly being at least partially concealed behind the first door from the throat of the main body when the damper assembly is in the open configuration, and the second hinge assembly being at least partially concealed behind the second door from the throat of the main body when the damper assembly is in the open configuration,
the first door and the second door being sized and configured to completely prevent a flow of fluid along the axial fluid flow path when the damper assembly is in the closed configuration.

19. The damper assembly of claim 18, wherein:
the damper assembly is configured to transition from the closed configuration to the open configuration in response to a fluid flow acting against the first door and the second door from a first direction when the damper assembly is in the closed configuration; and
the damper assembly is configured to transition from the open configuration to the closed configuration in the absence of a fluid flow passing through the throat when the damper assembly is in the open configuration and/or in response to a fluid flow acting against the first door and the second door from a second direction opposite the first direction when the damper assembly is in the open configuration.

20. A door configured for use in a damper assembly, the door comprising:
a first end being configured to be hingedly coupled to the damper assembly;
a second end opposite the first end, the second end being a free end defining a mating surface;
a first opposing side extending between the first end and the second end;
a second opposing side extending between the first end and the second end, the second opposing side being opposite the first opposing side;
a forward surface; and
a rear surface opposite the forward surface, the door having a concave shape and at least one curvilinear edge.
